(19) United States
(12) Patent Application Publication
(10) Pub. No.: US 2010/0012226 A1
(43) Pub. Date: Jan. 21, 2010

(54) Multiple saw machine

(76) Inventor: W. Daniel Hamby, Valdese, NC (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/458,587

(22) Filed: Jul. 16, 2009

Related U.S. Application Data
(60) Provisional application No. 61/129,742, filed on Jul. 16, 2008.

(51) Int. Cl. B27C 9/00; B27B 25/04; B23Q 15/00

(52) U.S. Cl. 144/4.3; 144/245.2; 144/356

(57) ABSTRACT

The multiple saw machine includes a rigid mainframe that provides mountings and attachments for all mechanical components. The components include multiple saw frames, conveyor belts, transfer chains and drive shafts for providing motive power for the conveyor belts, saw blades and transfer chains. A computer and an array of sensors are employed to monitor the saw machine functions and to control the timing of and location of board cutting.

### CROSS-REFERENCE TO RELATED APPLICATION

This application claims the benefit of U.S. Provisional Patent Application Ser. No. 61/129,742, filed Jul. 16, 2008.

### BACKGROUND OF THE INVENTION

1. Field of the Invention

The present invention generally relates to woodworking machines. More specifically, the present invention relates to a multiple saw machine for cutting and sorting boards.

2. Description of the Related Art

The woodworking industry is highly competitive, and any advance made in processing lumber, particularly the cutting and sorting of boards, leads to increased efficiency, which, in turn, leads to increased profit margins. The utilization of computer technology to control the operations of sawing and sorting has the potential to reduce manpower requirements at the saw machine itself while decreasing the incidence of error. Jobs lost at the saw machine stations will be recovered, at least in part, in jobs created in computer operations and monitoring. The overall increase in efficiency and quality would certainly create a positive financial effect for the woodworking industry. Thus a multiple saw machine solving the aforementioned problems is desired.

### SUMMARY OF THE INVENTION

The multiple saw machine comprises a rigid mainframe that provides mountings and attachments for all mechanical components, including multiple saw frames, conveyor belts, transfer chains and drive shafts for providing motive power for the conveyor belts, saw blades and transfer chains. A computer and an array of sensors are employed to monitor the saw machine functions and to control the timing and location of board cutting.

Accordingly, the invention presents an improved machine for cutting and processing boards in an efficient and high quality manner. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is a top view of a multiple saw machine according to the present invention.

FIG. 2 is an end view of a multiple saw machine according to the present invention.

FIG. 3 is an enlarged detail view of area 3 of FIG. 2, showing the slide bar of a multiple saw machine according to the present invention.

Similar reference characters denote corresponding features consistently throughout the attached drawings.

### DETAILED DESCRIPTION OF THE PREFERRED EMBODIMENTS

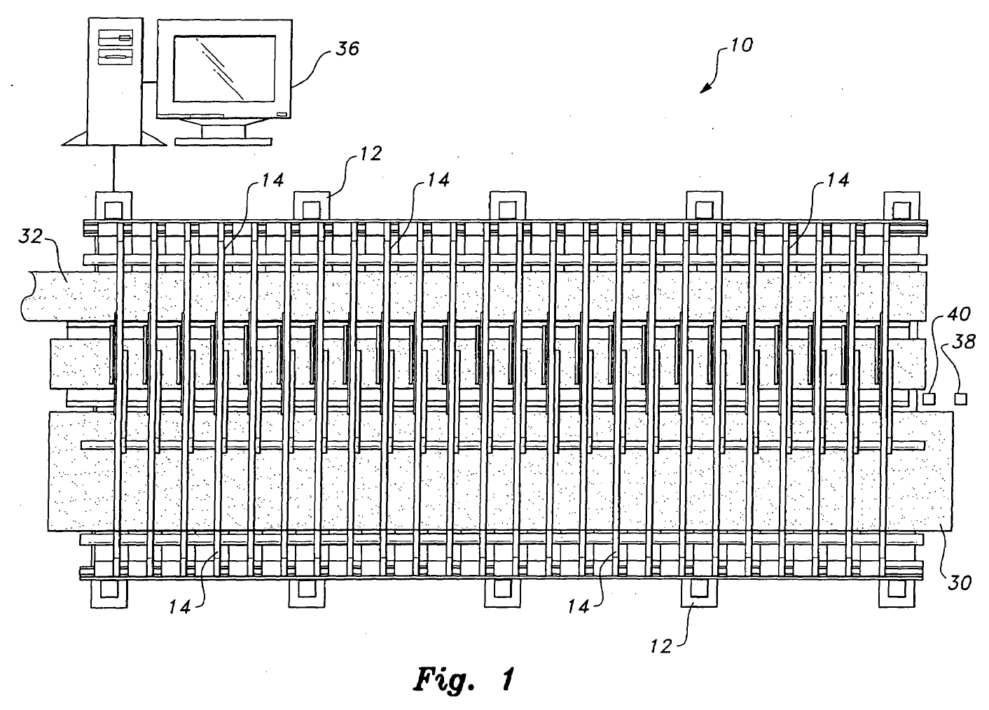

Referring to FIGS. 1-3, the multiple saw machine 10 includes a mainframe 12 fabricated from metal stock and welded to form a rigid and rugged structure for supporting all mechanical components of the saw machine. A plurality of saw frames 14 are mounted for linear movement on guide rails 16.

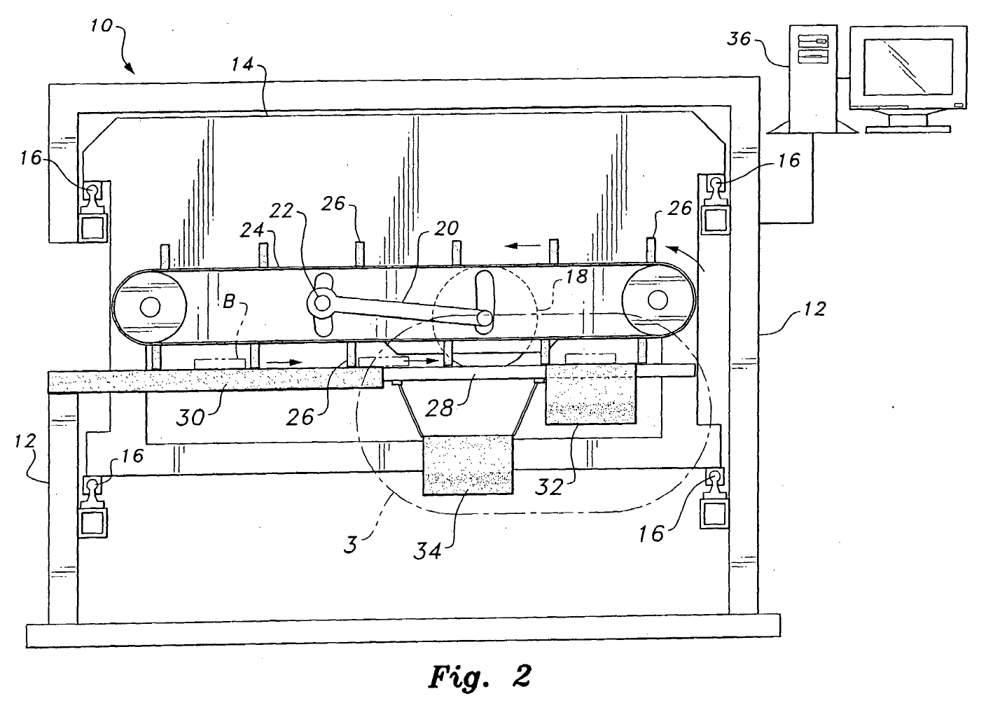

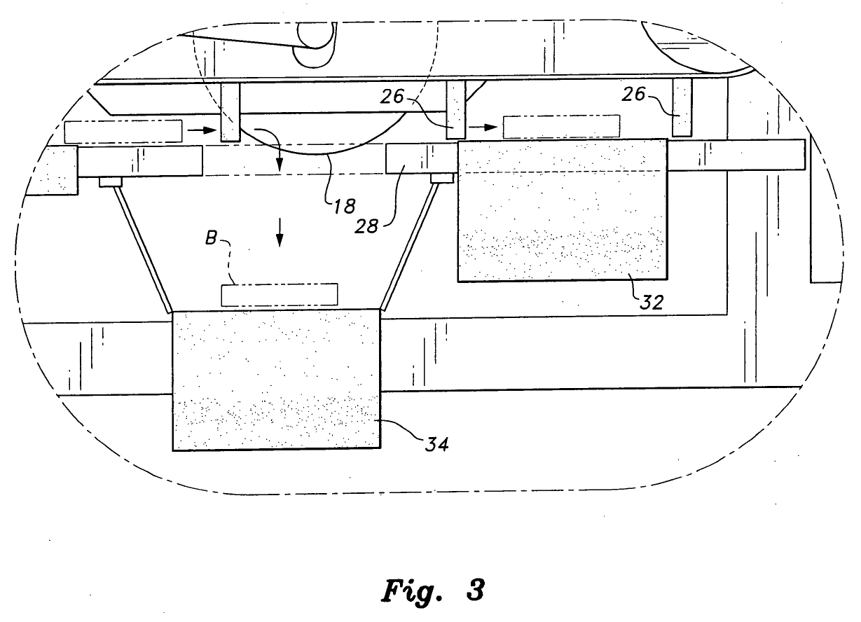

As best seen in FIG. 2, each saw frame 14 is of rigid construction and includes conventional means (drive belts, bearings, sheaves, etc.) for mounting a saw blade 18. The saw blade 18 is mounted on a swing arm 20 for substantially vertical movement. A sliding saw blade drive system 22 provides motive power to saw blade 18. A plurality of indexing chain assemblies 24 is spaced along the length of the saw machine 10. Each assembly 24 includes a continuous roller chain having dog attachments 26 evenly spaced therearound. A loading table 30 is disposed at the entrance of the machine 10 for positioning boards B thereron. A first conveyor belt 32 is disposed at the exit of the machine 10 to convey processed boards therefrom. As shown more clearly in FIG. 3, a second conveyor belt 34 is disposed beneath a sliding section 28 to receive defective board sections, as will be further explained below. A computer 36 monitors and controls all machine and process functions. At least two sensors 38, 40 are positioned to sense board positions and relay the data to the computer.

In use, boards B to be processed are placed on loading table 30 in the loading zone of the machine 10. Sensor 38 is positioned to scan table 30 and signals computer 36 that a board B has been placed on the loading table 30 for processing. Sensor 40 is positioned to sense the leading and trailing edges of the board B and signals the computer 36 to initiate the processing cycle, initiating movement of indexing chains 24 and starting a process timer. The dogs 26 of Indexing chains 24 sweep the boards into the next zone. Swing arms 20 deploy saw blades 18 to cut the board as programmed into the computer 36. Saw blades 18 will cut the board into good and bad sections as determined by a scanner in sensor 40. The scanner instructs the computer 36 to open certain retractable sections 28 if a bad section is disposed thereon, thereby allowing the bad sections to fall on conveyor belt 34 for conveyance out of the machine for discard or other use. The good board sections are swept to conveyor belt 32 and exit the machine. Belt 32 may deliver the boards to another machine for further processing. The sensors, computer and scanners control, monitor and time the process to allow for continuous board feed.

It is to be understood that the present invention is not limited to the embodiments described above, but encompasses any and all embodiments within the scope of the following claims.

I claim:

1. A multiple saw machine, comprising:
a mainframe having an entrance side and an exit side;
a plurality of saw frames mounted on the mainframe;
a plurality of indexing chain assemblies mounted on the mainframe;
a loading table adapted for receiving boards to be processed, the loading table being positioned adjacent the entrance side of the mainframe; and
a conveyor belt adapted for receiving processed boards, the conveyor belt being positioned adjacent the exit side of the mainframe.

2. The multiple saw machine according to claim 1, further comprising a plurality of guide rails disposed on said mainframe, said plurality of saw frames being mounted on the guide rails for linear movement thereon.

3. The multiple saw machine according to claim 1, wherein said loading table is spaced from said conveyor belt, the multiple saw machine further including a plurality of retractable sections disposed between said loading table and said conveyor belt.

4. The multiple saw machine according to claim 1, wherein each said saw frame includes a saw blade and a swing arm mounted thereto for raising and lowering the saw blade.

5. The multiple saw machine according to claim 1, wherein each said indexing chain assembly includes a continuous roller chain having dog attachments evenly spaced therearound.

6. The multiple saw machine according to claim 1, further including a plurality of sensors disposed adjacent said loading table for sensing the placement and position of the boards to be processed.

7. A multiple saw machine, comprising:
a mainframe having an entrance side and an exit side;
a plurality of saw frames mounted on the mainframe;
a plurality of indexing chain assemblies mounted on the mainframe;
a loading table adapted for receiving boards to be processed, the loading table being positioned adjacent the entrance side of the mainframe;
a first conveyor belt spaced from the loading table, the first conveyor belt being adapted for receiving processed boards, the first conveyor belt being positioned adjacent the exit side of the mainframe;
a plurality of guide rails disposed on the mainframe, the plurality of saw frames being mounted on the guide rails for linear movement thereon;
a plurality of retractable sections disposed between the loading table and the first conveyor belt; and
a second conveyor belt positioned beneath the retractable sections.

8. The multiple saw machine according to claim 7, wherein each said saw frame includes a saw blade and a swing arm mounted thereto for raising and lowering the saw blade.

9. The multiple saw machine according to claim 7, wherein each said indexing chain assembly includes a continuous roller chain having dog attachments evenly spaced therearound.

10. The multiple saw machine according to claim 7, further including a plurality of sensors disposed adjacent said loading table for sensing the placement and position of the boards to be processed.

11. The multiple saw machine according to claim 7, further including a computer for monitoring and controlling all saw machine functions.

12. A multiple saw machine, comprising:
a mainframe having a length, an entrance side and an exit side;
a plurality of saw frames mounted on the mainframe along the length thereof;
a plurality of indexing chain assemblies mounted on the mainframe, the chain assemblies being evenly spaced along the length of the mainframe;
a loading table adapted for receiving boards to be processed, the loading table being positioned adjacent the entrance side of the mainframe;
a first conveyor belt spaced from the loading table, the first conveyor belt being adapted for receiving processed boards, the first conveyor belt being positioned adjacent the exit side of the mainframe;
a plurality of guide rails disposed on the mainframe, the plurality of saw frames being mounted on the guide rails for linear movement thereon;
a plurality of retractable sections disposed between the loading table and the conveyor belt; and
a second conveyor belt positioned beneath the retractable sections.

13. The multiple saw machine according to claim 12, wherein each said saw frame includes a saw blade and a swing arm mounted thereto for raising and lowering the saw blade.

14. The multiple saw machine according to claim 12, wherein each said indexing chain assembly includes a continuous roller chain having dog attachments evenly spaced therearound.

15. The multiple saw machine according to claim 12, including:
a plurality of sensors disposed adjacent said loading table for sensing the placement and position of the boards to be processed and producing data relative to the placement and position; and
a computer for receiving the produced data, the computer monitoring and controlling all saw machine functions.
